(19) United States
(12) Patent Application Publication
(10) Pub. No.: US 2013/0328256 A1
(43) Pub. Date: Dec. 12, 2013

(54) CLAMPING DEVICE

(71) Applicant: Heidelberger Druckmaschinen AG, Heidelberg (DE)

(72) Inventors: ADOLF PHILLIP GREINER, SINSHEIM (DE); JOSEF SCHELL, WALLDORF (DE); MICHAEL THOME, ST. LEON-ROT (DE); HERIBERT WILLE, SINSHEIM (DE)

(21) Appl. No.: 13/911,263

(22) Filed: Jun. 6, 2013

(30) Foreign Application Priority Data
Jun. 6, 2012 (DE) 10 2012 011 337.4

(51) Int. Cl. B23B 31/42

(52) U.S. Cl. CPC B23B 31/42
USPC 269/48.1

(57) ABSTRACT

A clamping device is adjustable and capable of transmitting high torques, with little material and cost outlay. A clamping sleeve has an outer contour which can be adjusted, with an elastic change in shape, by radially adjustable rolling bodies disposed in the interior of the clamping sleeve. The outer contour has a nominal shape in an expanded state of the clamping sleeve.

### CROSS-REFERENCE TO RELATED APPLICATION

This application claims the priority, under 35 U.S.C. § 119, of German Patent Application DE 10 2012 011 337.4, filed Jun. 6, 2012; the prior application is herewith incorporated by reference in its entirety.

### BACKGROUND OF THE INVENTION

1. Field of the Invention:

The invention relates to a clamping device including a clamping sleeve having an outer contour which can be adjusted, with an elastic change in shape, by rolling bodies which are disposed in the interior of the clamping sleeve and which can be adjusted radially.

Clamping sleeves, expansion-type clamping mandrels, expansion mandrels or clamping bushings serve for load-transmitting retention of a workpiece or tool. The workpiece or the tool has a precision bore and, for clamping, is pushed over the clamping sleeve. In order to perform clamping, the outer diameter of the clamping sleeve is enlarged, in such a way that a force-locking connection is generated between the sleeve and a bore wall. A force-locking connection is one which connects two elements together by force external to the elements, as opposed to a form-locking connection which is provided by the shapes of the elements themselves.

German Patent DE 10 26 152 discloses an expansion mandrel in which a ring of balls is disposed in a sleeve between a clamping nut and an abutment. The balls of the ring of balls move radially outward with an axially movable adjusting ball. In the process, the sleeve is expanded radially.

German Patent DE 660 546, corresponding to U.S. Pat. No. 2,206,373, presents a clamping connection between two bodies. On one body there is seated a first cone on which rolling bodies run. As a result of an axial movement of a counterpart cone, the rolling bodies are pressed against the first cone in such a way that the first body is elastically deformed and pressed against the second body.

A disadvantage of the devices of the prior art is that the radial deformation of the sleeve or of an equivalent element is non-uniform. The deformation is more intense at the point of engagement or at a line of engagement of a rolling body which effects the radial expansion than in regions between rolling bodies. The surface of the sleeve or of the equivalent element has shape deviations which have the effect that retention forces for the workpiece or the tool are reduced.

### SUMMARY OF THE INVENTION

It is accordingly an object of the invention to provide a clamping device, which overcomes the hereinafore-mentioned disadvantages of the heretofore-known devices of this general type and which is adjustable and capable of transmitting high torques, with little material and cost outlay.

Furthermore, a clamping sleeve of the clamping device should offer the possibility of adapting a nominal clamping diameter by exchanging only one or a few elements.

With the foregoing and other objects in view there is provided, in accordance with the invention, a clamping device, comprising a clamping sleeve having an interior, and radially adjustable rolling bodies disposed in the interior. The clamping sleeve has an outer contour configured to be adjusted, with an elastic change in shape, by the rolling bodies and the outer contour has a nominal shape in an expanded state of the clamping sleeve.

According to the invention, a clamping sleeve has a nominal shape, in particular a cylindrical nominal shape, in the expanded state. The shape deviations that arise during the expansion of the clamping sleeve can be avoided by virtue of the clamping sleeve undergoing finish machining, to produce the nominal shape, in the expanded state. The nominal shape may, for example, be attained by using a cutting machining process such as external cylindrical grinding.

A peculiarity of the clamping sleeve is that the rolling bodies used for the change in shape of the outer contour always act at the same location in the interior of the clamping sleeve. In this way, the elastic changes in shape to attain the nominal shape are reproducible. If balls in a cage are used for the elastic deformation, then the cage may be disposed so as to be axially movable but rotationally conjoint with respect to the outer sleeve. In this case, the balls interact with a conical surface of a spindle.

Other features which are considered as characteristic for the invention are set forth in the appended claims.

Although the invention is illustrated and described herein as embodied in a clamping device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a clamping device with axial actuation by a clamping nut;

FIG. 2 is a longitudinal-sectional view of the clamping device according to FIG. 1;

FIG. 3 is a perspective view of a ball-guiding bushing with rotational securing grooves;

FIG. 4 is a perspective view of a clamping device with radial actuation;

FIG. 5 is a fragmentary, sectional view of the clamping device according to FIG. 4; and

FIG. 6 is a perspective view showing details of cam surfaces of an actuating element.

### DETAILED DESCRIPTION OF THE INVENTION

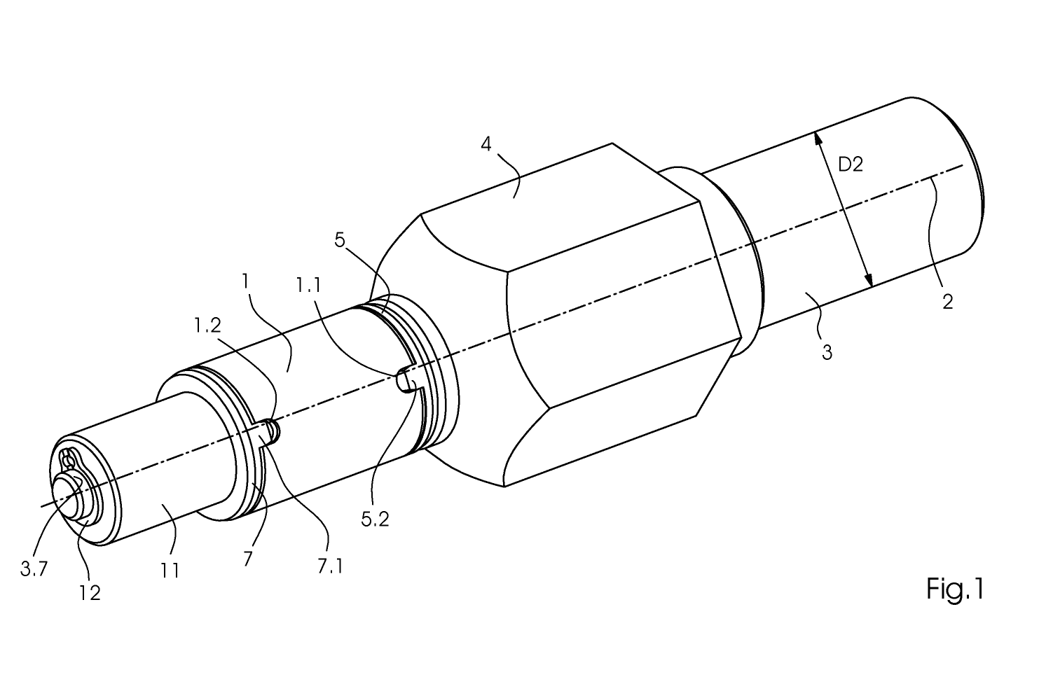

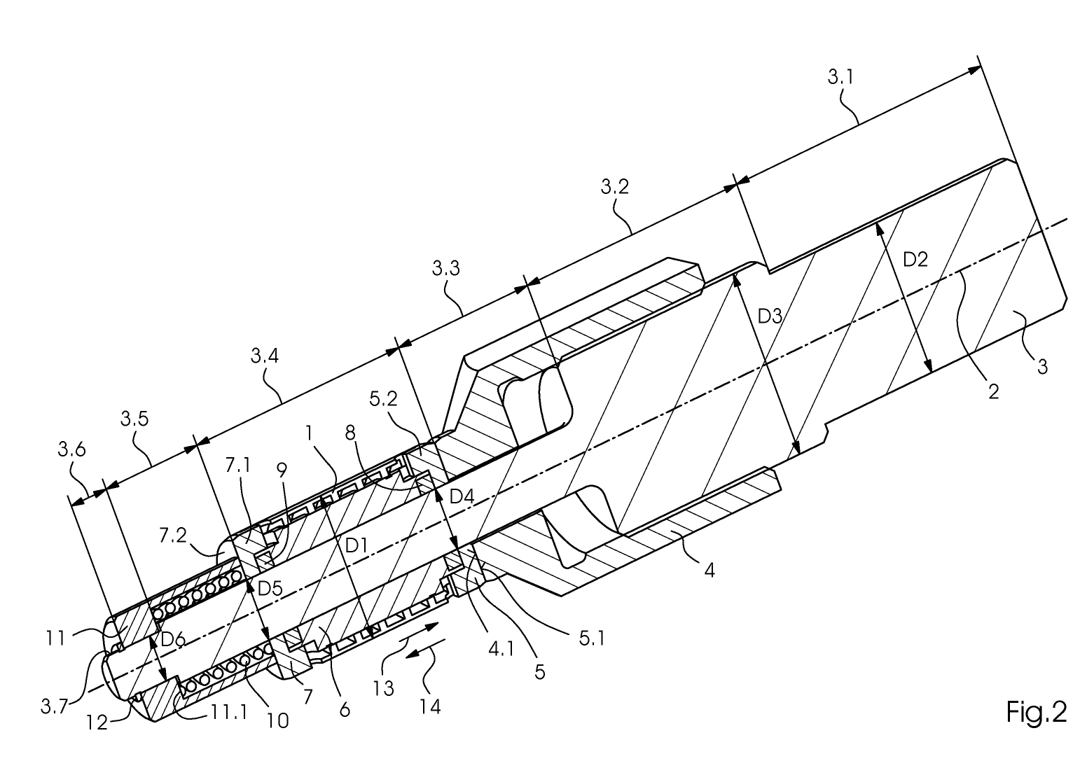

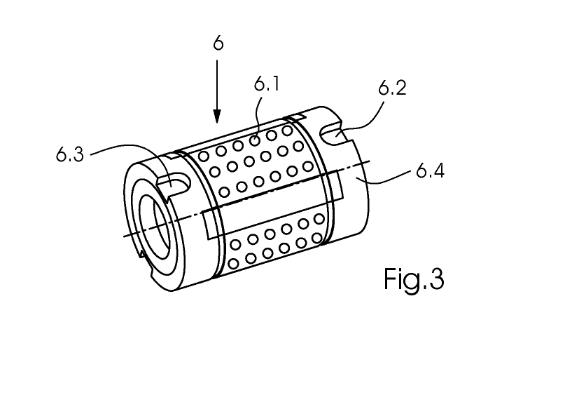

Referring now to the figures of the drawings in detail and first, particularly, to FIGS. 1-3 thereof, there is seen a first embodiment of a clamping device having a clamping sleeve 1 with a cylindrical nominal shape. The clamping sleeve 1 has a nominal diameter D1 and lies coaxially with respect to an axis 2 of a spindle 3. The spindle 3 has a cylindrical pin or peg 3.1 with a diameter D2 to be received in a chuck of a machine tool. The pin or peg 3.1 is followed in the direction of the axis 2 by an externally threaded region 3.2 with a diameter D3>D2. The externally threaded region 3.2 is followed by a cylindrical region 3.3 with a diameter D4<D2. In a further region 3.4, the spindle 3 has a conical form, in which the diameter increases by 40 μm over the length of the region 3.4 from the diameter D4 to D5. The conical region 3.4 is followed by a cylindrical region 3.5 with a diameter D5 and by a further cylindrical region 3.6 which is reduced in diameter to D6<D5.

An adjusting nut 4 with an external hexagon is screwed onto the external thread 3.2. The adjusting nut 4 has an end surface 4.1 against which an end surface 5.1 of a washer 5 bears. A ball-guiding bushing 6 and the sleeve 1 are pushed onto the spindle 3 in the conical region 3.4. Balls 6.1 of the bushing 6 run on the conical surface in the region 3.4 and bear against the inner side of the sleeve 1. The sleeve 1 and the bushing 6 are followed in the axial direction by a further washer 7. Lugs 5.2, 7.1 which engage into axial cutouts 6.2, 6.3 of the bushing 6 and 1.1, 1.2 of the sleeve 1, are situated on the washers 5, 7 so as to face towards the sleeve 1 and the bushing 6. The sleeve 1 is thus rotationally secured with respect to the bushing 6. If required, the sleeve 1 may be exchanged for a different sleeve with a different nominal diameter Dl. Seals 8, 9 are disposed on the spindle 3 in the conical region 3.4 at both sides of a cage 6.4, so that the seals prevent fouling of the ball-guiding bushing 6.

The washer 7 is followed in the direction of the axis 2 by a compression spring 10 which is surrounded by a bushing 11. The compression spring 10 is supported against an end side 7.2 of the washer 7 and against an inner end side 11.1 of the bushing 11. The bushing 11 is secured against axial movement by using a lock washer 12. The lock washer 12 is seated in a groove 3.7 on the end of the spindle 3.

A workpiece or tool to be clamped is pressed with a bore over the sleeve 1. In order to permit this, the adjusting nut 4 is screwed in the direction of an arrow 13. As a result of the force of the spring 10, the bushing 6 and the washers 5, 7 are moved in a direction 13, in such a way that the balls 6.1 are situated in a conical region having a small diameter. In this non-clamped state, the balls 6.1 do not exert a radial force on the inner side of the sleeve 1.

In order to clamp the workpiece or tool on the surface of the sleeve 1, the adjusting nut 4 is screwed in the direction of an arrow 14. The washers 5, 7 and the bushing 6 are moved in the direction 14 counter to the force of the spring 10, in such a way that the balls 6.1 pass into the conical region 3.4 with increasing diameter. As a result of the conical form in the region 3.4, the balls 6.1 are moved radially outward during the movement in the axial direction 14. As a result, the sleeve 1 is expanded in terms of the diameter D1 to the nominal diameter. The sleeve 1 bears in a closely-fitting manner against a bore surface of the workpiece or tool. The pressure force of the sleeve 1 against the bore surface is large enough that a desired torque can be reliably transmitted.

Where the following description mentions reference numerals which have already been introduced above, these refer to equivalent elements.

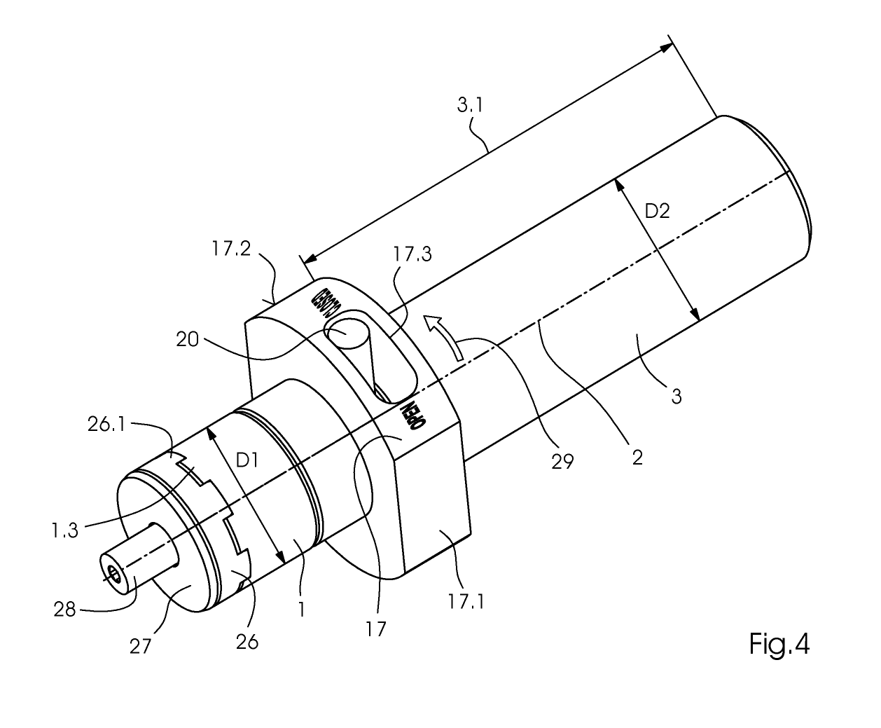

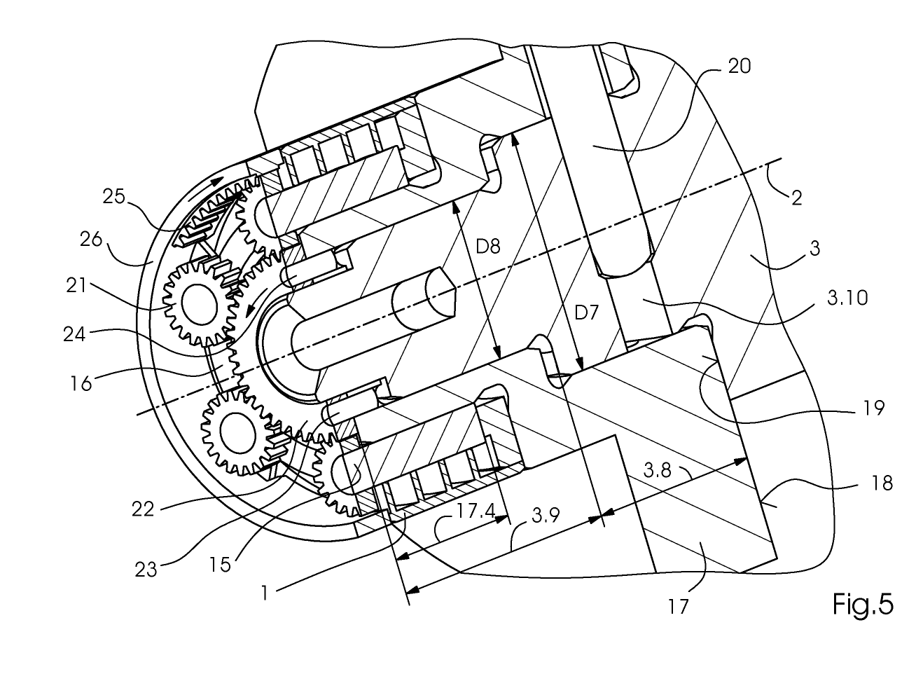

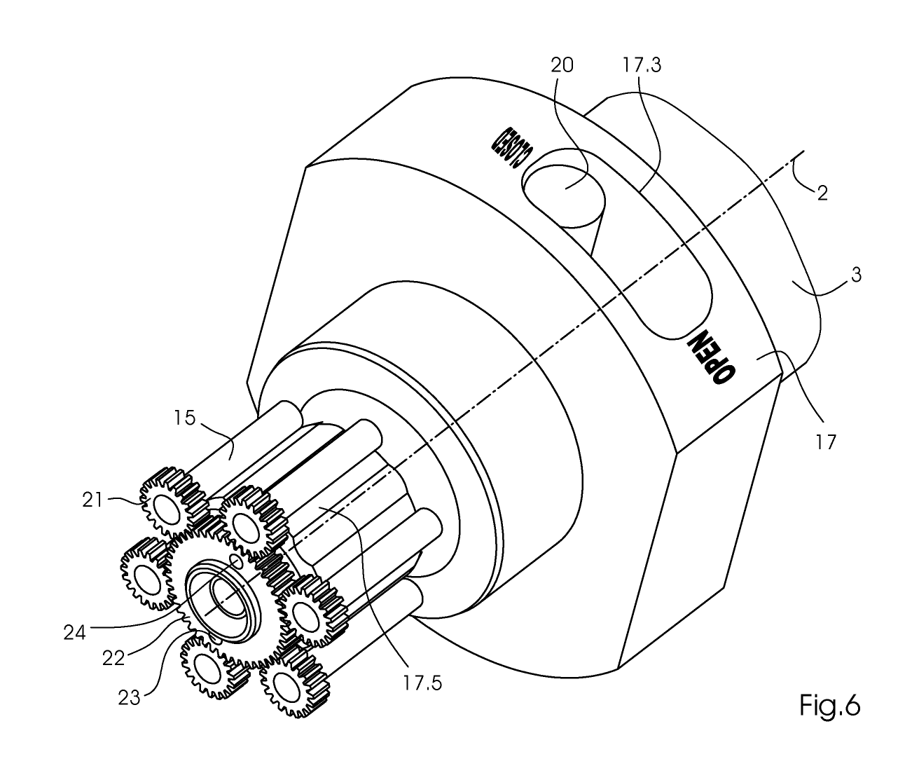

FIGS. 4-6 show an alternative embodiment of a clamping sleeve 1 which is expanded by using cylindrical rollers 15, for the clamping of a workpiece or tool. The cylindrical rollers 15 are seated in a cage 16 and, like the sleeve 1, are disposed coaxially with respect to the axis 2 of a spindle 3. The spindle 3 has a cylindrical shank with a diameter D2 at an end to be received in a machine chuck and in a region 3.1. The other end of the spindle 3 has a stepped form. An adjusting element 17 is disposed in regions 3.8 and 3.9 having spindle diameters D7 and D8. An end surface 18 of the adjusting element 17 bears in the direction of the axis 2 against a stop surface 19 of the spindle 3. The adjusting element 17 has two parallel surfaces 17.1, 17.2 for the engagement of an open-ended wrench. The adjusting element 17 has a slot 17.3, transversely with respect to the axis 2, through which a pin 20 projects. The pin is driven transversely with respect to the axis 2 into a bore 3.10 of the spindle 3. The adjusting element 17 is rotatable about the axis 2 on a diameter D8 of the spindle 3. The rotational movement of the adjusting element 17 is limited by the slot 17.3. As is seen in FIG. 6, cam surfaces 17.5 are formed in an axial region 17.4 on the lateral surface of the adjusting element 17, correspondingly to the number of cylindrical rollers 15.

Gear wheels 21 are seated rotationally conjointly on the end of each cylindrical roller 15, in each case on the side remote from the adjusting element 17. The gear wheels 21 are in engagement with a central wheel 22. The gear wheel 22 is disposed rotationally conjointly and coaxially on the end of the spindle 3 by using pins 23, 24. One of the gear wheels 21 is in engagement with a toothed segment 25 on the inner side of a ring 26. The ring 26, which is disposed coaxially with respect to the axis 2, has rectangular teeth 26.1 which are disposed on an end side and are in engagement with end-side teeth 1.3 of the sleeve 1. The engagement of the ring 26 with the sleeve 1 is secured by a washer 27 which is held on the spindle 3 by a screw 28.

For clamping, a workpiece or tool is pushed with a bore over the sleeve 1 having the nominal diameter D1, and the adjusting element 17 is rotated relative to the spindle 3 in the direction of the arrow 29 by using a wrench. In this case, the pin 20 in the slot 17.3 passes from the mark “open” in the direction of the mark “closed”. Due to the cam surfaces 17.5, the cylindrical rollers 15 move radially outward and are pressed against the inner side of the sleeve 1. As a result of the contact pressure, the sleeve 1 is expanded in the elastic range, in such a way that contact pressure is generated between the sleeve 1 and the bore surface of the workpiece or tool. The contact pressure between the sleeve and the workpiece or tool is large enough that a desired torque can be transmitted.

As a result of the rotational securing with the gear wheels 21, 22, the toothed segment 25 and the end-side meshing engagement between the rings 26 and the sleeve 1, it is ensured that the rollers 15 always build up the contact pressure at the same location in the interior of the sleeve 1.

1. A clamping device, comprising:
a clamping sleeve having an interior; and
radially adjustable rolling bodies disposed in said interior;
said clamping sleeve having an outer contour configured to be adjusted, with an elastic change in shape, by said rolling bodies, said outer contour having a nominal shape in an expanded state of said clamping sleeve.

2. The clamping device according to claim 1, wherein said nominal shape of said outer contour, in said expanded state of said clamping sleeve, is matched to an inner contour of a body to be clamped.

3. The clamping device according to claim 1, wherein said outer contour has a cylindrical shape with a nominal diameter.

4. The clamping device according to claim 1, which further comprises:
a sleeve axis; and
a conical surface coaxial to said sleeve axis;
said rolling bodies being spherical and interacting with said conical surface.

5. The clamping device according to claim 4, which further comprises:
a cage being axially movable and rotationally secured relative to said clamping sleeve; and
a spindle having said conical surface;
said spherical rolling bodies being seated in said cage and interacting with said conical surface of said spindle.

6. The clamping device according to claim 4, which further comprises:
two axially movable washers each having a respective lug pointing in direction of said sleeve axis;
said conical surface disposed between said two axially movable washers;
a cage disposed along with said clamping sleeve in a region of said conical surface; and
said cage and said clamping sleeve each having at least one respective cutout in which said lugs are respectively engaged, said cutouts running in direction of said sleeve axis.

7. The clamping device according to claim 4, which further comprises:
a washer having an end surface;
said spindle having a thread; and
a clamping nut disposed on said thread of said spindle, said clamping nut having an end surface bearing against said end surface of said washer.

8. The clamping device according to claim 7, which further comprises a spring, said washer being spaced apart from said clamping nut and supported in direction of said sleeve axis against said spring.

9. The clamping device according to claim 1, which further comprises an actuating element having cam surfaces, said rolling bodies having a roller-shaped form and interacting with said cam surfaces.

10. The clamping device according to claim 1, wherein said nominal shape is produced by a cutting machining process in said expanded state of said clamping sleeve.
